(19) United States
(12) Patent Application Publication
(10) Pub. No.: US 2023/0078876 A1
(43) Pub. Date: Mar. 16, 2023

(54) Clutch mechanism of electric tools

(71) Applicant: Li-Chu Lin Yang, Changhua County (TW)

(72) Inventor: Li-Chu Lin Yang, Changhua County (TW)

(21) Appl. No.: 17/473,990

(22) Filed: Sep. 13, 2021

(51) Int. Cl. B25F 5/00; B25B 21/00

(52) U.S. Cl. CPC B25F 5/001; B25B 21/00

(57) ABSTRACT

A clutch mechanism of electric tools has a driving shaft, a clutch mechanism, and a torque adjusting unit. An end of the driving shaft is connectable to an internal motor and another end of the driving shaft has a sliding sleeve, and a first spring is disposed between the driving shaft and the sliding sleeve. The clutch mechanism has a toothed ring secured onto the tool, the toothed ring having a clutching plate connected to the driving shaft, the toothed ring further having a sun gearing set and a planetary gearing set internally. The torque adjusting unit has a fixed sleeve secured onto the toothed ring and engaging an adjusting sleeve at a front end, a cap, a second spring and a bearing ring sequentially sleeved onto the driving shaft, a plurality of plugs passing through the fixed sleeve being sandwiched between the adjusting sleeve and the cap.

### BACKGROUND OF INVENTION

### Field of Invention

The present invention relates to a clutch mechanism of electric tools.

### Description of the Related Art

Most of electric screwdrivers and other electric tools mainly use an electric motor to drive a screw head to rotate through a transmission module to lock screws, nuts . . . and other parts onto the work object, or to unscrew the screws, nut . . . and other parts from the work object.

However, the current common electric screwdriver roughly includes a main shaft formed by connecting multiple rods. One end of the main shaft is connected to a motor, and the other end is connected to a clutch mechanism. The clutch mechanism is installed in a sleeve, and the clutch mechanism includes several clutching plate and a gear ring set for connecting with the clutching plates. When in use, the main shaft is driven by the motor to drive the gear ring set to drive the clutching plates to rotate, and the clutching plates can drive the tool head, so that the tool can tight or loose the object through the rotation of the tool head.

However, the above-mentioned conventional structure still has the following problems in practical application: the sleeve, the shaft, the clutch mechanism, the clutching plate, gear ring and other components of the electric screwdriver are all made of steel. Therefore, the electric screwdriver has heavy overall weight; also, the shaft includes too many rods to connect, which results in the driving torque cannot be too large and prone to wear or breakage.

Therefore, it is desirable to provide a clutch mechanism of electric tools to mitigate and/or obviate the aforementioned problems.

### SUMMARY OF THE INVENTION

An objective of present invention is to provide a clutch mechanism of electric tools.

To achieve these and other objects of the present invention, a clutch mechanism of electric tools has a driving shaft, a clutch mechanism, and a torque adjusting unit. An end of the driving shaft is connectable to an internal motor of the electric tool via the clutch mechanism and another end of the driving shaft has a sliding sleeve configured to accept various tool heads, and a first spring is disposed between the driving shaft and the sliding sleeve, the first spring pushing the sliding sleeve. The clutch mechanism comprises a toothed ring secured onto the tool, the toothed ring having a clutching plate connected to the driving shaft, the toothed ring further having a sun gearing set and a planetary gearing set internally, engagement among the toothed ring, the sun gearing set and the planetary gearing set further incorporating the clutching plate. The torque adjusting unit has a fixed sleeve secured onto the toothed ring and engaging an adjusting sleeve at a front end, a cap, a second spring and a bearing ring sequentially sleeved onto the driving shaft, the cap and the bearing ring respectively pushing two ends of the second spring, a plurality of plugs passing through the fixed sleeve being sandwiched between a closed end of the adjusting sleeve and the cap.

Other objects, advantages, and novel features of invention will become more apparent from the following detailed description when taken in conjunction with the accompanying drawings.

### BRIEF DESCRIPTION OF DRAWINGS

FIG. 1 is a three-dimensional assembly drawing of a preferred embodiment of the present invention.

FIG. 2 is a three-dimensional exploded view of preferred embodiment of the present invention.

FIG. 3 is a cross-sectional view of the combination of preferred embodiment of the present invention.

FIG. 4 is another combined cross-sectional and partial enlarged view of preferred embodiment of the present invention.

### DETAILED DESCRIPTION OF THE PREFERRED EMBODIMENT

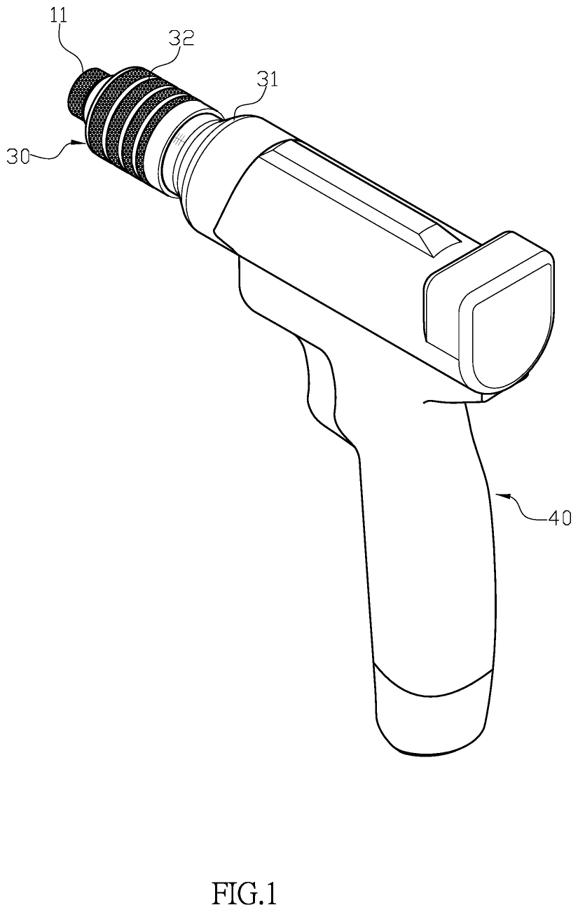

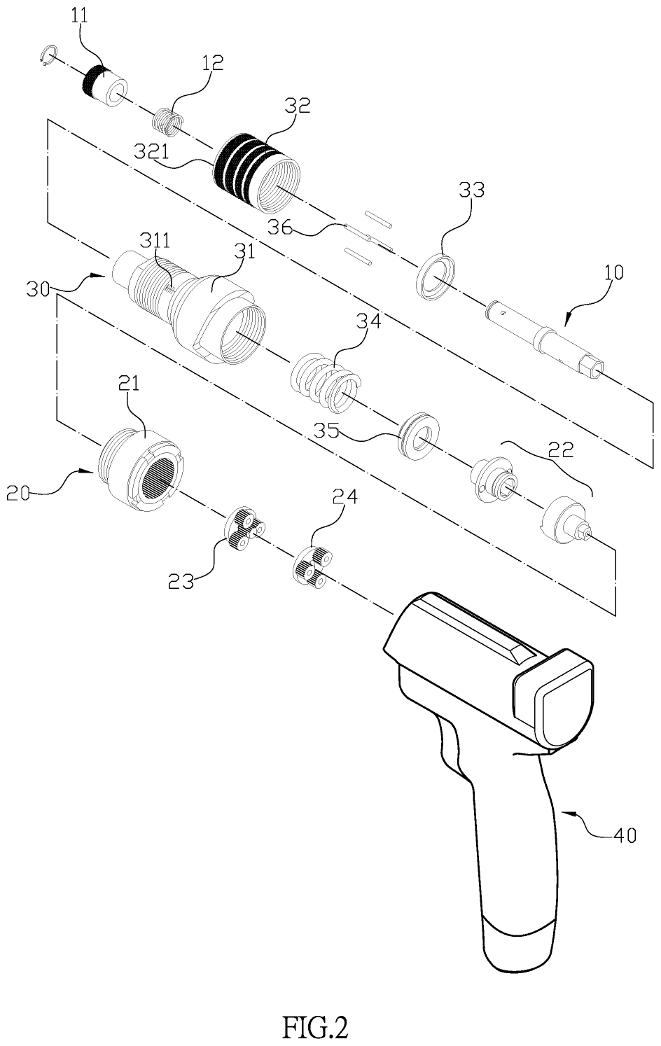

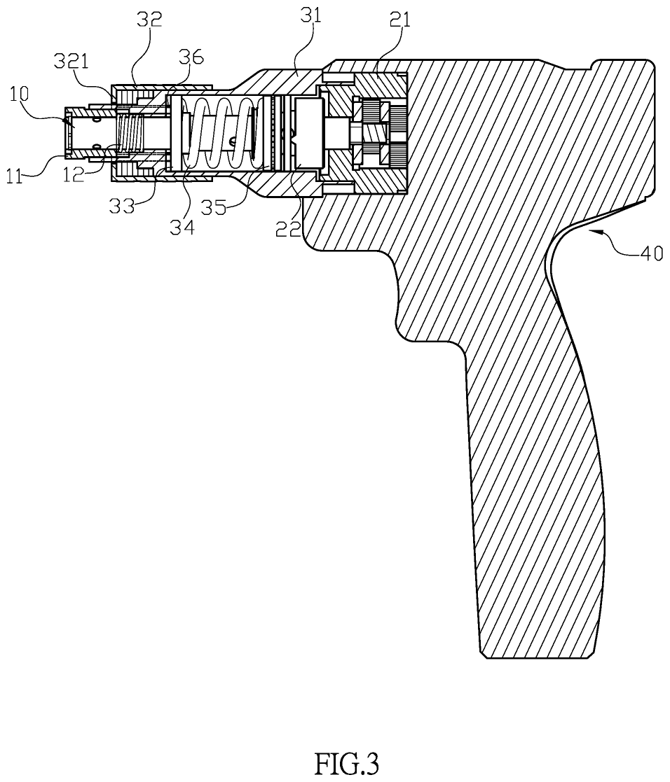

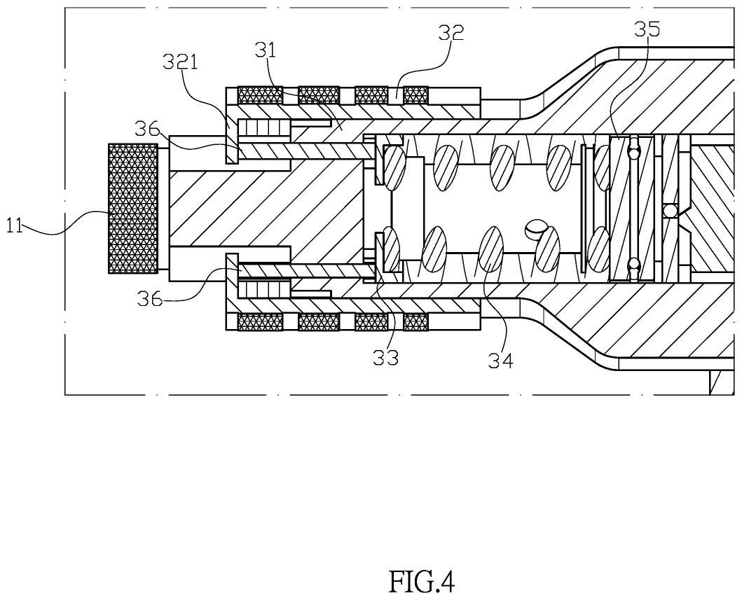

First, please refer to FIGS. 1-4. A clutch mechanism of electric tools comprises a driving shaft 10, a clutch mechanism 20 and a torque adjusting unit 30. An end of the driving shaft 10 is connectable to an internal motor of the electric tool 40 via the clutch mechanism 20 and another end of the driving shaft has a sliding sleeve 11 configured to accept various tool heads. A first spring is disposed between the driving shaft 10 and the sliding sleeve 11, and the first spring 12 pushes the sliding sleeve 11, such that the tool head engaged with the driving shaft 10 is held tightly by the sliding sleeve 11 with the elasticity provided by the first spring 12. The clutch mechanism 20 has a toothed ring 21 secured onto the tool 40, the toothed ring 21 has a clutching plate 22 connected to the driving shaft 10. The toothed ring 21 further having a sun gearing set 23 and a planetary gearing set 24 internally, and engagement among the toothed ring 21, the sun gearing set 23 and the planetary gearing set 24 further incorporate the clutching plate 22. Therefore, in conjunction with the engagement or separation of the clutching plate 22 during shifting, the electric tool 40 can have at least two power modes to choose from: low speed, high torque, high speed, and low torque. The torque adjusting unit 30 has a fixed sleeve 31 secured onto the toothed ring 21, engaging with an adjusting sleeve 32 and having at a front end, a cap 33, a second spring 34 and a bearing ring 35 sequentially sleeved onto the driving shaft 10. The cap 33 and the bearing ring 35 respectively pushing two ends of the second spring 34, and a plurality of plugs 36 passing through the fixed sleeve 31 are sandwiched between a closed end 321 of the adjusting sleeve 32 and the cap 33. Through the clockwise and count screw rotation of the adjusting sleeve 32 on the fixed sleeve 31, the plug 36 is able to change the distance between the cap 33 and the bearing ring 35, so that the torque applied by the second spring 34 to the driving shaft 10 can be changed synchronously. Furthermore, the fixed sleeve 31 and the adjusting sleeve 32 are made of aluminum alloy, so that the overall weight of the power tool can be lighter, which can achieve the requirements of lighter weight.

Moreover, the tool head engaging with the driving shaft 10 is a screw driver head.

In addition, the toothed ring 21 is made of aluminum alloy.

Furthermore, the toothed ring 21 is provided with at least one bearing configured for rotation of the driving shaft 10.

The fixed sleeve 31 is marked with scales 311 for indication.

There are four plugs 36 between the closed end 321 of the adjusting sleeve 32 and the cap 33.

The improvement of the above-mentioned clutch mechanism of the electric tool has the following characteristics: 1. the fixed sleeve 31, the adjusting sleeve 32, and the toothed ring 21 are all made of aluminum alloy, so that the overall weight of the electric tool can be lighter; 2. the driving shaft 10 is a whole piece, so the output torque can be greater, and it is not easy to malfunction or damage; 3. through rotation of the adjusting sleeve 32 on the fixed sleeve 31 to change the distance between the cap 33 and the bearing ring 35 allows the torque applied on the driving shaft 10 by the second spring 34 to be changed simultaneously; and 4. the plugs 36 used to control the compression or elastic extension of the second spring 34 has the specific effect of simplifying the structure of the torque adjusting unit 30 on the electric tool.

Although the present invention has been explained in relation to its preferred embodiment, it is to be understood that many other possible modifications and variations can be made without departing from the spirit and scope of invention as hereinafter claimed.

What is claimed is:

1. A clutch mechanism of electric tools comprising: a driving shaft, a clutch mechanism, and a torque adjusting unit, wherein:
an end of the driving shaft is connectable to an internal motor of the electric tool via the clutch mechanism and another end of the driving shaft has a sliding sleeve configured to accept various tool heads, and a first spring is disposed between the driving shaft and the sliding sleeve, the first spring pushing the sliding sleeve;
the clutch mechanism comprises a toothed ring secured onto the tool, the toothed ring having a clutching plate connected to the driving shaft, the toothed ring further having a sun gearing set and a planetary gearing set internally, engagement among the toothed ring, the sun gearing set and the planetary gearing set further incorporating the clutching plate; and
the torque adjusting unit has a fixed sleeve secured onto the toothed ring and engaging an adjusting sleeve at a front end, a cap, a second spring and a bearing ring sequentially sleeved onto the driving shaft, the cap and the bearing ring respectively pushing two ends of the second spring, a plurality of plugs passing through the fixed sleeve being sandwiched between a closed end of the adjusting sleeve and the cap.

2. The clutch mechanism of electric tools as claimed in claim 1, wherein the tool head inserted in the driving shaft is a screw driver head.

3. The clutch mechanism of electric tools as claimed in claim 1, wherein the toothed ring is made of aluminum alloy.

4. The clutch mechanism of electric tools as claimed in claim 1, wherein the fixed sleeve is marked with scales for indication.

5. The clutch mechanism of electric tools as claimed in claim 1, wherein there are four plugs disposed between the closed end of the adjusting sleeve and the cap.

6. The clutch mechanism of electric tools as claimed in claim 1, wherein the fixed sleeve and the adjusting sleeve are made of aluminum alloy.
